(19) United States
(12) Patent Application Publication
(10) Pub. No.: US 2007/0215219 A1
(43) Pub. Date: Sep. 20, 2007

(54) Variable load valve with test point

(75) Inventors: James T. Dewberry, Greer, SC (US); Scott N. Griffin, Moore, SC (US)

Correspondence Address: THE WEBB LAW FIRM, P.C., 700 KOPPERS BUILDING, 436 SEVENTH AVENUE, PITTSBURGH, PA, 15219, US

(73) Assignee: Wabtec Holding Corporation, Wilmerding, PA (US)

(21) Appl. No.: 11/378,975

(22) Filed: Mar. 17, 2006

(51) Int. Cl. F16K 37/00

(52) U.S. Cl. 137/557

(57) ABSTRACT

A variable load control valve comprising a load control chamber, a control port for communication with a source of control fluid under pressure and a test point associated with the control port. The test point is normally configured to permit communication between a source of control fluid and the load control chamber. The test point has a first testing configuration permitting communication by both the source of pressure and the load control chamber with a test port. The test point has a second testing configuration permitting communication only between the load control chamber and the test port.

### BACKGROUND OF THE INVENTION

1. Field of the Invention

This invention relates to a variable load valve which functions to limit maximum air pressure directed to brake cylinders in proportion to the vehicle weight as indicated, for example, by air spring pressure in a railroad vehicle. More particularly, this invention is directed to variable load valves of the type wherein a test point is provided for monitoring the pressure in the load control chamber or for pressurizing the load control chamber of the variable load control valve without pressuring the system that feeds the load control chamber.

2. Description of Related Art

Variable load control valves are well-known components of railway air brake systems. Such valves are described, for example, in U.S. Pat. Nos. 3,517,771; 3,583,772; and 5,340,203. While the details of variable load control valves may vary, especially with regard to release of the braking pressure, all such valves have common features; namely, a supply chamber, a delivery chamber, and a load control chamber. The delivery chamber is separated from the load control chamber by a piston arranged to control a valve between the supply and delivery chambers. The load control chamber is connected to a system for supplying air pressurized generally proportional to the vehicle load, for example, the air in the air spring system.

Current variable load valve designs known to the inventors can only receive the air spring pressure, for example, and react to changes in that pressure but nothing else. There is a need to verify the brake system function at various car weights by allowing controlled pressure to be sent to the variable load valve for test purposes. It is an object of this invention to provide an integral test point at the variable load valve to allow testing of the brake system at simulated car weights without disconnecting the car piping or using other less accurate test means.

### SUMMARY OF THE INVENTION

The variable load valve with test point according to this invention provides improved testing of railway vehicle brake systems by providing verification of key features of the system.

Briefly, according to this invention, there is provided a variable load control valve having a test point associated with a load control port. The test point has a piston biased in a first position cutting off the test point entry port from the load control port and the system piping. In a second position achieved by partially overcoming the bias, the test point entry port is placed in communication with the system piping and the load control chamber. In a third position achieved by still further overcoming the bias, the entry port is only in communication with the load control chamber. This position is useful for injecting controlled pressures for testing.

According to a preferred embodiment, a variable load control valve with integral test point comprises an upper casing section, an intermediate casing section, and a lower casing section secured together so that the intermediate section abuts the upper and lower casing sections. A supply chamber having a supply port and a delivery chamber having a delivery port are formed in the upper casing section with a valve seat positioned therebetween. A valve stopper is urged by a biasing device toward the valve seat. A load control chamber is formed in the lower casing section having a control port for communication with a source of control fluid under pressure. A piston cylinder is formed in the intermediate section. A piston having working faces in communication with the delivery chamber and the load control chamber is positioned in the piston cylinder. The piston has associated linkage for contacting the valve stopper so that the piston in one position holds the valve stopper off the valve seat. Thus, when fluid under pressure is conveyed from the supply chamber, the fluid under pressure in the delivery chamber is limited to a maximum value by seating of the valve stopper in accordance with the pressure in the load control chamber. A test point is associated with the load control port in the load control chamber and the source of control fluid. The test point has a spring-biased plunger with an entry port and communication passage therein. The plunger is normally biased in a first position permitting isolating the entry port and allowing communication between the source of pressure and the load control chamber. The plunger has a first testing position permitting communication with both the source of control fluid and the load control chamber with the entry port. The plunger has a second testing position permitting communication only between the load control chamber and the entry port.

### BRIEF DESCRIPTION OF THE DRAWINGS

Further features and other objects and advantages will become clear from the following detailed description made with reference to the drawings in which:

FIG. 1 is a schematic section through one embodiment of a load control valve with integral test point according to this invention;

FIG. 2 is a section through the test point in the first position isolating the entry port and permitting flow from the source of control fluid and the load control chamber; and

FIG. 3 is a section through the test point in the third position providing communication between the entry port and the load control chamber and the source of control fluid.

### DESCRIPTION OF THE PREFERRED EMBODIMENTS

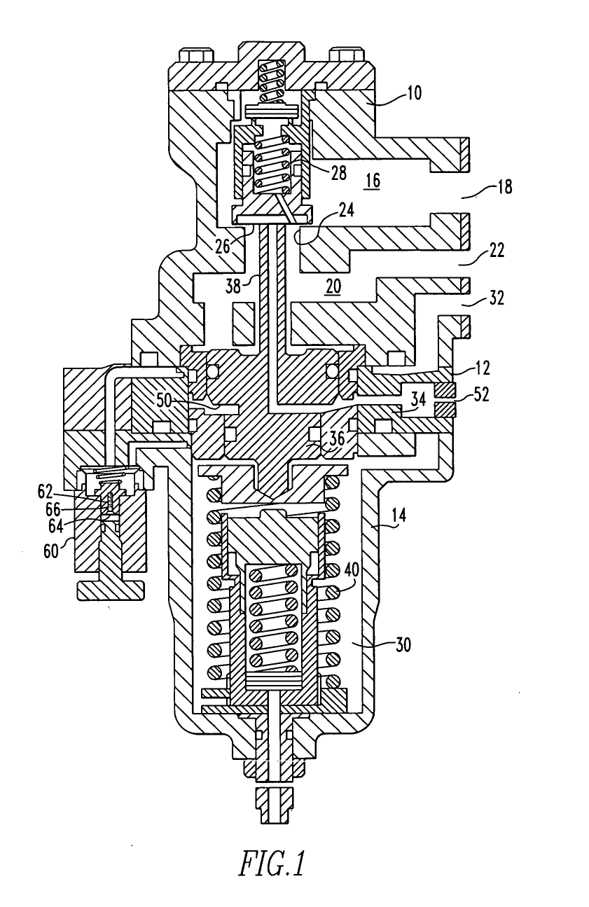

Referring to FIG. 1, a typical load control valve has an upper casing section 10, an intermediate casing section 12, and a lower casing section 14 secured together so that the intermediate section abuts the upper and lower casing sections. A supply chamber 16 having a supply port 18 and a delivery chamber 20 having a delivery port 22 are formed in the upper casing section 10 with a valve seat 24 positioned between the supply chamber and delivery chamber. A valve stopper 26 is urged by a spring 28 toward the valve seat 24.

A load control chamber 30 is formed in the lower casing section 14 having control port 32 for communication with a source of control fluid under pressure, for example, the air spring pressure.

A piston cylinder 34 is formed in the intermediate casing section 12. A piston 36 in the piston cylinder has working faces in communication with the delivery chamber 20 and the load control chamber 30. The piston has an associated stem 38 contacting the valve stopper 26 and, when the piston is in raised positions (as shown in the drawing), it holds the valve stopper 26 off the valve seat 24.

A spring 40 is provided in the load control chamber 30 to urge the piston toward the delivery chamber 20. Fluid under pressure in the load control chamber 30 and the spring 40 urge the piston toward the delivery chamber 20. Fluid under pressure in the delivery chamber urges the piston toward the control chamber. If the force on the piston due to the spring and fluid in the control chamber is greater than the force of the fluid in the delivery chamber, then the piston will move the stem to keep the valve open. Otherwise, the valve is closed. Thus, the pressure in the control chamber limits the pressure in the delivery chamber by allowing the valve to close when pressure in the delivery chamber on the piston provides a force that exceeds the force on the other face of the piston provided by the control pressure and the spring. This limits to a maximum value of the pressure in the delivery chamber and at the delivery port by seating of the valve stopper.

Once the valve is closed, the pressure in the delivery chamber cannot be reduced since the delivery port is connected to a brake cylinder. To enable release, an intermediate piston surface 50 is connected to release port 52 in the manner described in U.S. Pat. No. 3,460,872, for example.

All that has been described so far is old in the art. The improvement, according to this invention, is the inclusion of an integral test point 60. The test point is associated with the load control port in the load control chamber and the source of control fluid, such as air spring pressure.

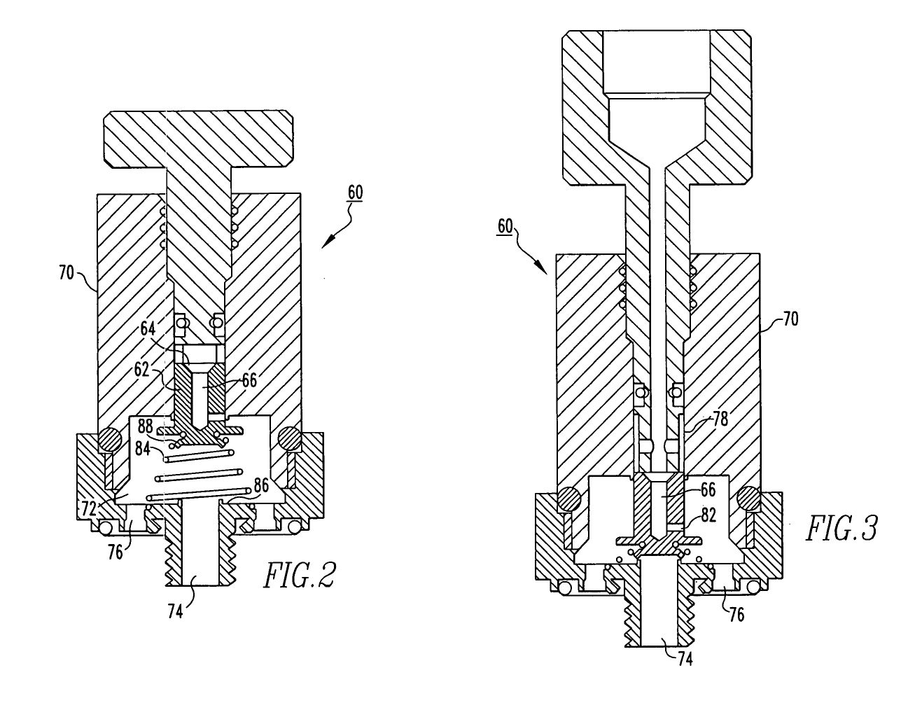

Referring to FIGS. 2 and 3, the test point 60 has a spring-biased plunger 62 with a test port (or entry port) 64 and passage 66 therein. The plunger 62 is normally in a position permitting communication between the source of control fluid and the load control chamber 30 (see FIG. 2). The plunger has a first testing position (see FIG. 3) permitting communication with both the source of pressure and the load control chamber with the entry port. The plunger has a second testing position permitting communication only between the load control chamber and the entry port.

Control fluid under pressure from the rail vehicle air suspension system enters the variable load valve from manifold porting and is passed through the intermediate casing section and into the input port at the center of the test point. With the test point, the air spring pressure can be passed through (normal operation), monitored, or externally controlled.

Referring again to FIGS. 2 and 3, the test point 60 comprises a body 70 defining a transfer chamber 72 having a fluid inlet port 74 in communication with the source of control pressure and a fluid outlet port 76 in communication with the load control chamber 30 and defining a piston cylinder 78 in communication with the transfer chamber and entry port 64. The piston or plunger 62 is slidably positioned in the piston cylinder. The piston has an entry port 64 at the one axial end and an axial passageway 66 extending partially through the piston from the entry port but terminating before the other axial end of the piston. The piston has a radial passage 82 in communication with the axial passage and with the exterior cylindrical surface of the piston. A spring 84 in the transfer chamber biases the piston away from the transfer chamber such that the radial passage in the piston is blocked by the wall of the piston cylinder. The fluid inlet port 74 is axially aligned with the piston and defines a valve seat 86.

The piston has a valve stopper 88 on the closed axial end thereof for being seated in the valve seat 86 when the piston is depressed against the spring. In this position, the radial passage in the piston opens into the transfer chamber. In this position, the entry port is in communication only with the outlet port. In this position, testing pressures can be injected into the control chamber without affecting the upstream system (e.g., the air spring system).

The piston has an intermediate position where the valve stopper is not seated and the radial passage is in communication with the transfer chamber in which position the entry port is in communication with both the inlet and outlet ports. In this position, the pressure in the control chamber can be monitored during normal operation.

Having thus described the invention in the detail and particularity required by the patent laws, what is desired protected by Letters Patent is set forth in the following claims.

The invention claimed is:

1. In a variable load control valve with a load control chamber and a control port for communication with a source of control fluid, the improvement comprising:
a test point associated with the control port and the load control chamber and connectable with a source of control fluid, said test point normally configured to permit communication between a source of control fluid and the load control chamber, said test point having a test port, said test point having a first testing configuration permitting communication by both the source of pressure and the load control chamber with the test port, and said test point having a second testing configuration permitting communication only between the load control chamber and the test port.

2. A variable load control valve with an integral test point having a test port, said test point being associated with a load control port and a load control chamber and connectable with a source of control fluid, said test point having a spring biased plunger with a test port and passage therein, said plunger normally in a position permitting communication between a source of control fluid and the load control chamber, said plunger having a first testing position permitting communication of the test port with both the source of control fluid and the load control chamber with the test port, and said plunger having a second testing position permitting communication only between the load control chamber and the test port.

3. A variable load control valve with integral test point comprising:
an upper casing section, an intermediate casing section and a lower casing section secured together so that the intermediate section abuts the upper and lower casing sections;
a supply chamber having a supply port and a delivery chamber having a delivery port, said chambers formed in the upper casing section with a valve seat positioned therebetween;
a valve stopper urged by a biasing means toward the valve seat;
a load control chamber formed in the lower casing section having control port for communication with a source of control fluid under pressure;
a piston cylinder formed in the intermediate section;
said piston having working faces in communication with the delivery chamber and the load control chamber, said piston having associated means for contacting the valve stopper such that when the piston is in positions near the delivery chamber the valve stopper is held off the valve seat and fluid under pressure is conveyed from said supply chamber to the delivery chamber; and
a test point associated with the load control port in the load control chamber and said source of control fluid, said test point having a spring biased plunger with a test port and a passage therein, said plunger normally in a position permitting communication between the source of control fluid and the load control chamber, said plunger having a first testing position permitting communication be both the source of control fluid and the load control chamber with the test port, and said plunger having a second testing position permitting communication only between the load control chamber and the test port.
